(19) United States
(12) Patent Application Publication
(10) Pub. No.: US 2025/0346183 A1
(43) Pub. Date: Nov. 13, 2025

(54) CAMERA MONITOR SYSTEM WITH PICTURE-IN-PICTURE FEATURE

(71) Applicant: Stoneridge Electronics AB, Solna (SE)

(72) Inventors: Troy Cooprider, White Lake, MI (US); Banuprakash Murthy, Novi, MI (US); Huimin Mattmuller, Rochester Hills, MI (US)

(21) Appl. No.: 18/659,202

(22) Filed: May 9, 2024

(51) Int. Cl. B60R 1/23; B60K 35/215; B60K 35/22; B60K 35/23; B60K 35/29; B60K 35/81

(52) U.S. Cl. CPC B60R 1/23; B60K 35/215; B60K 35/22; B60K 35/29; B60K 35/81; B60K 35/23; B60K 2360/1438; B60K 2360/1526; B60K 2360/176; B60K 2360/1876; B60K 2360/195; B60K 2360/782; B60K 2360/788; B60R 2300/105; B60R 2300/607; B60R 2300/802

(57) ABSTRACT

A method of providing views in a CMS for a vehicle includes capturing multiple fields of view with multiple cameras, displaying the multiple fields of view on multiple displays, one of which includes a primary display, touching a picture-in-picture (PIP) indicium on the primary display to select a predetermined PIP configuration that displays one of the multiple fields of view for at least one of the multiple displays, and displaying the predetermined PIP configuration on the at least one of the multiple displays during a first vehicle operational state. The predetermined PIP configuration is absent from the at least one of the multiple displays during a second vehicle operational state that is different than the first vehicle operational state.

### TECHNICAL FIELD

This disclosure relates to a camera monitor system (CMS), and more particularly, to a method and apparatus for a CMS having touchscreen-based selectable PIP configurations.

### BACKGROUND

Vehicle camera systems for mirror replacement or for supplementing mirror views are utilized in commercial vehicles to enhance the ability of a vehicle operator to see a surrounding environment of the commercial vehicle. Camera monitor systems (CMS) utilize one or more cameras to provide an enhanced field of view to a vehicle operator. In some examples, the mirror replacement systems cover a larger field of view than a conventional mirror, or include views that are not fully obtainable via a conventional mirror.

There is a desire to improve operator visibility to reduce risk. One approach is to add more cameras and more displays to increase the viewable area around the vehicle. While this approach may reduce blind spots, the operator is required to manage more information making it difficult fully take advantage of additional displayed views.

### SUMMARY

In one example embodiment, a method of providing views in a camera monitor system for a vehicle includes a) capturing multiple fields of view with multiple cameras, b) displaying the multiple fields of view on multiple displays, one of which includes a primary display, c) touching a picture-in-picture (PIP) indicium on the primary display to select a predetermined PIP configuration that displays one of the multiple fields of view for at least one of the multiple displays, and d) displaying the predetermined PIP configuration on the at least one of the multiple displays during a first vehicle operational state, the predetermined PIP configuration is absent from the at least one of the multiple displays during a second vehicle operational state that is different than the first vehicle operational state.

In a further example embodiment of any of the foregoing embodiments, the multiple displays include a driver side display and a passenger side display. The driver side display and passenger side display are respectively mounted in close proximity to a driver side A-pillar and a passenger side A-pillar. Each of the driver side display and passenger side display provide a narrow angle view and a wide angle view of its respective side of the vehicle that is provided by the multiple fields of view.

In a further example embodiment of any of the foregoing embodiments, the multiple displays include at least one of a primary information display that is located behind a steering wheel, a secondary information display that is located centrally in a bottom half of a vehicle cabin, a front passenger side corner display that is located centrally in a top half of the vehicle cabin, and a heads-up display.

In a further example embodiment of any of the foregoing embodiments, the primary display corresponds to the driver side display.

In a further example embodiment of any of the foregoing embodiments, the primary display includes a touchscreen, and step c) is performed by touching the touchscreen.

In a further example embodiment of any of the foregoing embodiments, the method includes a step of touching the touchscreen to display the PIP indicium prior to performing step c), and step c) includes displaying a PIP options menu in response to touching the PIP indicium. The PIP options menu includes the predetermined PIP configuration.

In a further example embodiment of any of the foregoing embodiments, the PIP options menu includes at least one of the following predetermined PIP configurations: a PIP window of an image in proximity to a rear of a trailer of the vehicle, a PIP window of an image of a side of the trailer opposite a side of the at least one of the multiple displays, a PIP window of an image of a passenger side of the vehicle from a passenger vehicle cab corner aftward along a cab of the vehicle, a PIP window of an image of a passenger side of the vehicle from a passenger vehicle cab corner along a front of the cab, a PIP window of an image of a bird's eye view around the vehicle, and a PIP window of an image of a vulnerable road user.

In a further example embodiment of any of the foregoing embodiments, the predetermined PIP configuration relates to one of the multiple displays other than the primary display.

In a further example embodiment of any of the foregoing embodiments, step d) is performed automatically in response to the first vehicle operational state occurring, and includes a step e) of terminating the display of the predetermined PIP configuration based upon a triggering event.

In a further example embodiment of any of the foregoing embodiments, the first vehicle operational state includes the vehicle being in a reverse gear, one of the multiple fields of view includes an image that is in proximity to a rear of a trailer of the vehicle, and the predetermined PIP configuration corresponds to displaying the image on the at least one of the multiple displays.

In a further example embodiment of any of the foregoing embodiments, the first vehicle operational state includes the vehicle providing that has a trailer angle above a threshold, one of the multiple fields of view includes an image of a side of the trailer opposite a side on which the one of the multiple fields of view is located, and the predetermined PIP configuration corresponds to displaying the image on the at least one of the multiple displays.

In a further example embodiment of any of the foregoing embodiments, the first vehicle operational state includes the vehicle being in a forward gear and below a speed threshold, one of the multiple fields of view includes an image of a passenger side of the vehicle from a passenger vehicle cab corner aftward along a cab of the vehicle, and the predetermined PIP configuration corresponds to displaying the image on the at least one of the multiple displays.

In a further example embodiment of any of the foregoing embodiments, the first vehicle operational state includes the vehicle being in a forward gear and below a speed threshold, one of the multiple fields of view includes an image of a passenger side of the vehicle from a passenger vehicle cab corner along a front of a cab of the vehicle, and the predetermined PIP configuration corresponds to displaying the image on the at least one of the multiple displays.

In a further example embodiment of any of the foregoing embodiments, the first vehicle operational state includes the vehicle being below a speed threshold, and the multiple fields of view form a bird's eye view (BEV), and the predetermined PIP configuration corresponds to displaying the BEV on the at least one of the multiple displays.

In a further example embodiment of any of the foregoing embodiments, the first vehicle operational state includes detecting a vulnerable road user (VRU), one of the multiple fields of view includes an image of the VRU, and the predetermined PIP configuration corresponds to displaying an image that includes the VRU on the at least one of the multiple displays.

In another example embodiment, a camera monitor system (CMS) includes multiple cameras that are configured to capture multiple fields of view in proximity to a commercial vehicle, multiple displays that are configured to display images from the captured multiple fields of view, the multiple displays include a primary display having a picture-in-picture (PIP) indicium, and a controller that is in communication with the multiple cameras and the multiple displays. The controller is configured to select a predetermined PIP configuration that is responsive to a user touching the PIP indicium. The controller is configured to display the predetermined PIP configuration on the at least one of the multiple displays during a first vehicle operational state. The predetermined PIP configuration is absent from the at least one of the multiple displays during a second vehicle operational state that is different than the first vehicle operational state.

In a further example embodiment of any of the foregoing embodiments, the multiple displays include a driver side display and a passenger side display. The driver side display and passenger side display are respectively mounted in close proximity to a driver side A-pillar and a passenger side A-pillar. Each of the driver side display and passenger side display provide a narrow angle view and a wide angle view of its respective side of the vehicle that is provided by the multiple fields of view. The multiple displays include at least one of a primary information display that is located behind a steering wheel, a secondary information display that is located centrally in a bottom half of a vehicle cabin, a front passenger side corner display that is located centrally in a top half of the vehicle cabin, and a heads-up display.

In a further example embodiment of any of the foregoing embodiments, the primary display includes a touchscreen, the controller is configured to display the PIP indicium in response to the user touching the touchscreen. The controller is configured to display a PIP options menu in response to the user touching the PIP indicium. The PIP options menu includes the predetermined PIP configuration, and the controller is configured to select the predetermined PIP configuration in response to the user touching the predetermined PIP configuration from the PIP options menu.

In a further example embodiment of any of the foregoing embodiments, the PIP options menu includes at least one of the following predetermined PIP configurations: a PIP window of an image in proximity to a rear of a trailer of the vehicle;
a PIP window of an image of a side of the trailer opposite a side of the at least one of the multiple displays: a PIP window of an image of a passenger side of the vehicle from a passenger vehicle cab corner aftward along a cab of the vehicle, a PIP window of an image of a passenger side of the vehicle from a passenger vehicle cab corner along a front of the cab, a PIP window of an image of a bird's eye view around the vehicle, and a PIP window of an image of a vulnerable road user.

In a further example embodiment of any of the foregoing embodiments, the controller is configured to display the predetermined PIP configuration automatically in response to the first vehicle operational state occurring, and the controller is configured to terminate the display of the predetermined PIP configuration based upon a triggering event.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera mirror system (CMS) used to provide at least narrow and wide fields of view alongside the vehicle (e.g., Class II and Class IV views).

FIG. 2 is a schematic birds-eye view of the commercial truck of FIG. 1 with a CMS providing, for example, Class II, Class IV, Class V, Class VI, and Class VIII views.

FIG. 3 is a schematic top view of an example vehicle cabin interior.

FIG. 4 is a perspective view of the vehicle cabin interior of FIG. 3.

FIG. 5A is a schematic view of a left-hand display from FIG. 3.

FIG. 5B is a schematic view of a right-hand display from FIG. 3.

FIG. 6 is a flowchart of an example method of providing a predetermined picture-in-picture (PIP) configuration on one of the CMS displays.

FIG. 7 is one example primary display having a touchscreen used to provide a PIP indicium.

FIG. 8 is the primary display shown in FIG. 7 and having a PIP options menu.

FIG. 9 is one of the displays illustrating the predetermined PIP configuration during a first vehicle operational state.

FIG. 10 illustrates an example right-hand display illustrating a predetermined PIP configuration during an example first vehicle operational state.

### DETAILED DESCRIPTION

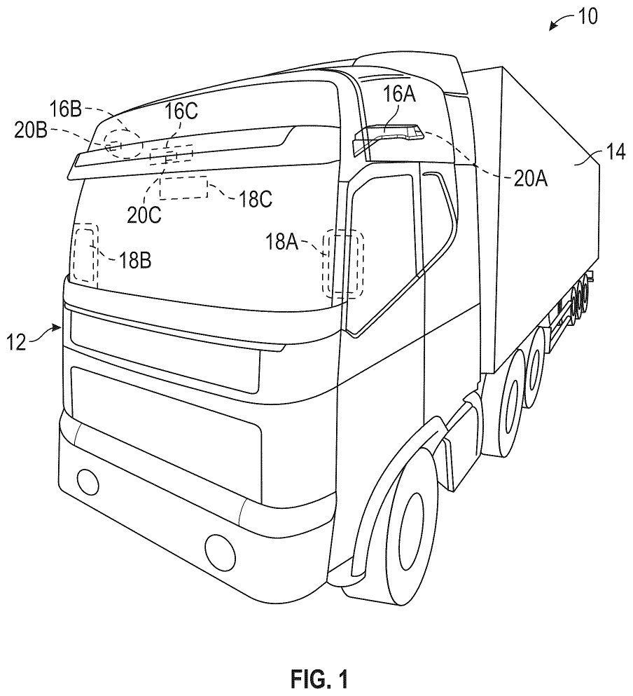

Schematic views of a commercial vehicle 10 are illustrated in FIGS. 1-4. The commercial vehicle 10 includes a vehicle cab or “tractor” 12 for pulling a trailer 14, where the trailer 14 articulates with respect to the tractor 12 during turns. Although the commercial vehicle 10 is depicted as a commercial truck with a single trailer in this disclosure, it is understood that other commercial vehicle configurations may be used (e.g., different types or quantities of trailers).

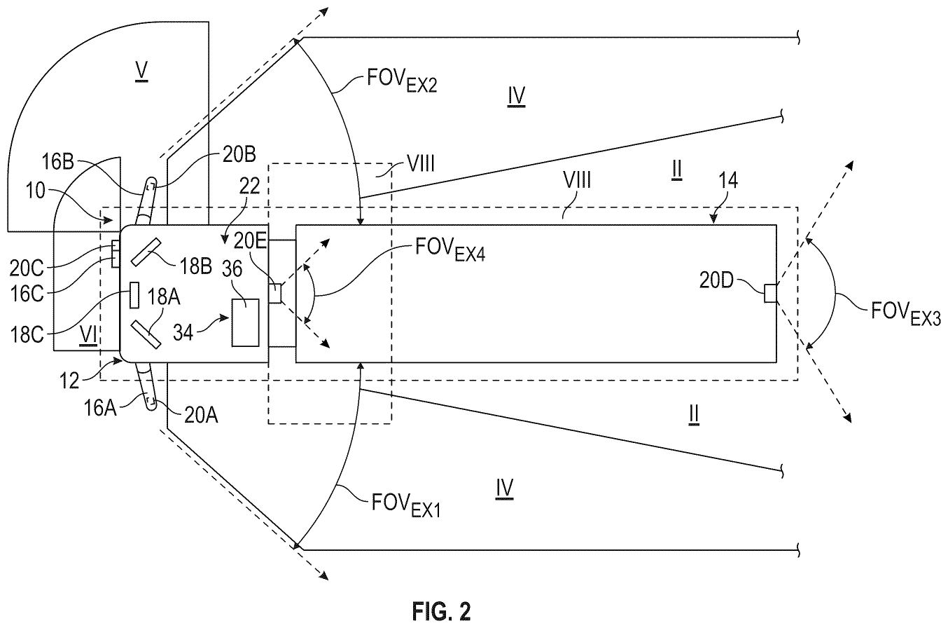

A pair of camera arms 16A-B include a respective base that is secured to, for example, the tractor 12. A pivoting arm is supported by the base and may articulate relative thereto. At least one rearward facing camera 20A-B is arranged respectively on or within the camera arms 16A-B. The exterior cameras 20A-B respectively provide an exterior field of view FOV_{EX1}, FOV_{EX2} that each include at least one of Class II and Class IV views (FIG. 2), which are legally prescribed views in the commercial trucking industry.

The Class II view on a given side of the commercial vehicle 10 is a subset of the class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries may have similar driver visibility requirements for commercial trucks. Any reference to a “Class” view is not intended to be limiting, but is intended as an example of the type of view provided to a display from a particular camera. For example, certain views may be prescribed in SAE J3155 or other regulations.

Each camera arm 16A-16B may also provide a housing that encloses electronics, e.g., a controller, that are configured to provide various features of the CMS 15. The camera arms 16A-B may be mounted either at a roof-mount location over the cab door (as shown), or on a door-mounted bracket or station, for example. If desired, the camera arms 16A-B may include conventional mirrors integrated with them as well, although the CMS 15 may be used to entirely replace mirrors. In additional examples, each side can include multiple camera arms, with each arm housing one or more cameras and/or mirrors.

If video of Class V and/or Class VI views is also desired, a camera housing 16C and camera 20C may be arranged at or near the front of the commercial vehicle 10 to provide those views (FIG. 2). Generally, Class V covers a passenger side of the vehicle from a passenger vehicle cab corner aftward along a cab of the vehicle, and Class VI covers a passenger side of the vehicle from a passenger vehicle cab corner along a front of a cab of the vehicle.

A backup camera 20D may be provided which provides a field of view FOV_{EX3}. The backup camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOV_{EX4}. The fifth wheel camera 20E may be mounted anywhere between the lateral plane of the fifth wheel fixture and the top/roof edge of the tractor, for example.

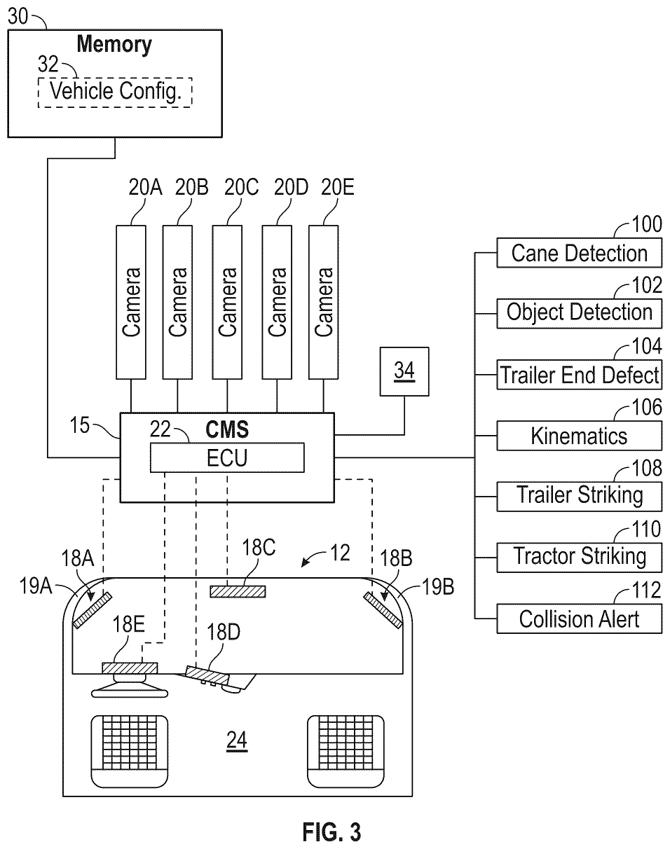

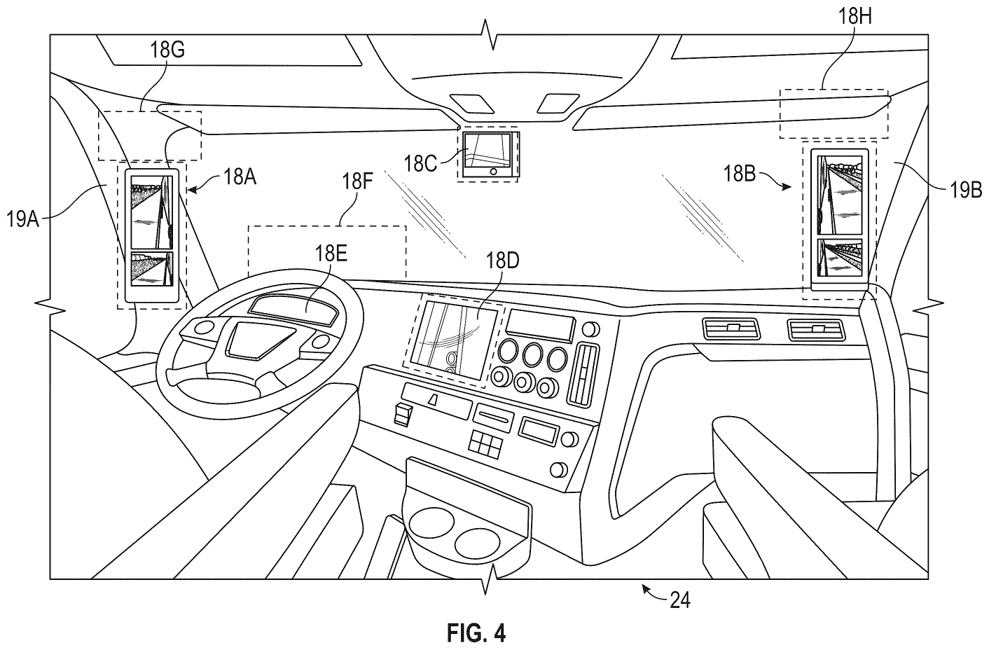

FIG. 3 is a schematic top view of an example vehicle cabin interior 24, and FIG. 4 is a perspective view of the vehicle cabin interior 24. Referring now to FIGS. 3-4 with continued reference to FIGS. 1-2, electronic displays 18A-E (e.g., which may be video displays, such as LCD displays) and cameras 20A-E are shown. The various electronic displays 18A-E and cameras 20A-E are part of a camera monitor system (CMS) 15, and therefore act as CMS displays and CMS cameras. As used herein, a “CMS camera” 20 is a camera configured to record images of an environment surrounding a commercial vehicle 10, and a “CMS display” 18 is an electronic display (e.g., an LCD) that is configured to image or display feeds from those cameras.

FIG. 4 illustrates additional or different displays 18F, 18G, 18H that may be used to display images from the cameras 20A-E or other cameras. For example, display 18F provides a heads-up-display (HUD) projected in the region of the driver side windshield. Displays 18G, 18H may be provided respectively on the A-pillars 19A, 19B to provide additional views to those of the displays 18A, 18B.

The CMS 15 includes a CMS controller or electronic control unit (ECU) 22 that acts as a controller and includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged in the vehicle cabin interior 24 near the top center of the windshield may be used to display the Class V and Class VI views, which are toward the front of the commercial vehicle 10, or a backup camera view (from camera 20D or 20E) to the driver. Display 18D is provided in a center console area of the vehicle cabin interior 24, generally located centrally in a bottom half of the vehicle cabin, and may be used for other purposes, such as navigation, infotainment, etc (i.e., a secondary information display). Display 18E may be part of an instrument cluster (i.e., a primary information display) located behind the steering wheel, for example.

If video of Class VIII views is desired, camera housings can be disposed at the sides and rear of the commercial vehicle 10 to provide fields of view including some or all of the Class VIII zones of the commercial vehicle 10. In such examples, one of the displays 18C-E may include one or more frames displaying the Class VIII views. The displays 18A, 18B, 18C face a driver region within the vehicle cabin interior 24 where an operator is seated on a driver seat.

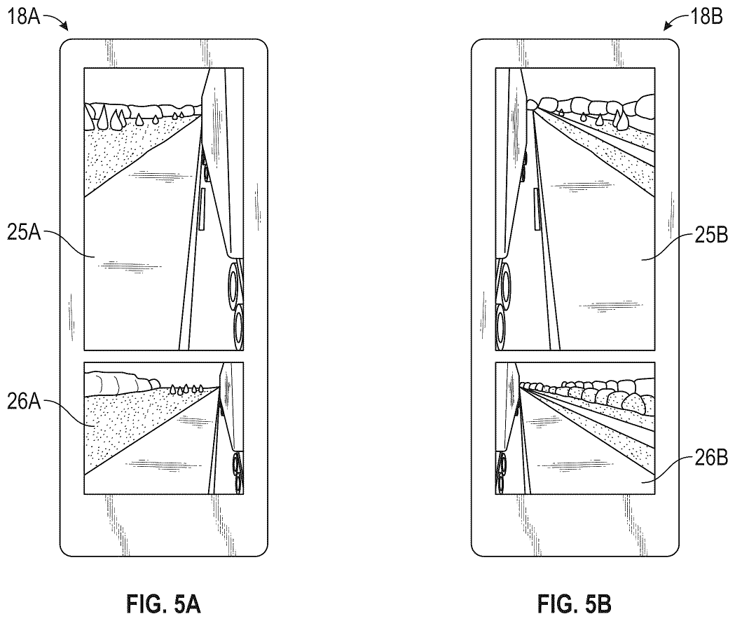

FIG. 5A is a schematic view of the left-hand side display 18A, and FIG. 5B is a schematic view of the right-hand side display 18B. Each display 18A-B includes a respective first display area 25A-B and a respective second display area 26A-B. In the example of FIGS. 5A-B, display area 25A is configured to display a Class II (narrow) view from camera 16A, and display area 26A is configured to display a Class IV (wide) view from camera 16A (or an additional, wide angle camera situated on the same side of the commercial vehicle as camera 16A). Similarly, display area 25B is configured to display a Class II (narrow) view from camera 16B, and display area 26B is configured to display a Class IV (wide) view from camera 16B (or an additional, wide angle camera situated on the same side of the commercial vehicle as camera 16B).

In various examples, the ECU 22 includes one or modules having algorithm(s), equation(s) and/or decision manager(s) that receive input(s) from sensors (e.g., cameras 20A-20E, ultrasonic, LiDar, radar, etc.) and/or stored values, as schematically illustrated in FIG. 3. Example modules include Lane Detection Module 100, Object Detection Module 102, Trailer End Detection Module 104, Kinematic Module 106, Trailer Striking Area Prediction Module 108, Tractor Striking Area Prediction Module 110, and Collision Alert Module 112. Example inputs include one or more sensors 34, such as a steering angle sensor, a vehicle speed sensor, gear position sensor, and/or other sensor data. Vehicle configuration information 32, which may be stored in memory 30, relates to vehicle characteristics (e.g., trailer length, axle position, trailer type/wheelbase, tractor configuration/wheelbase, hitch point location etc.), provided by the manufacturer, operator, and/or determined by one or more of the modules. During vehicle operation, the ECU 22 may communicate information to the driver, fleet operator, or others using an output (e.g, displays 18, speaker, etc.). Example operation and uses of these modules are disclosed in International Application No. PCT/US2023/083416 filed on Dec. 11, 2023, entitled “CAMERA MONITOR SYSTEM WITH TRAILER CURB STRIKE ALERT AND TRAILER STRIKING AREA,” which is incorporated herein by reference in its entirety.

The lane detection module 100 also uses image processing of the captured images to identify markings on the roadway, such as lane markers that visually divide adjacent lanes. One example algorithm is described in United States Publication No. US2023/117,719, entitled “CAMERA MIRROR SYSTEM DISPLAY FOR COMMERCIAL VEHICLES INCLUDING SYSTEM FOR IDENTIFYING ROAD MARKINGS”, which is incorporated by reference in its entirely. In that publication, a lane detection module is described in which an object detection algorithm identifies a lane marking in a roadway by filtering a color of the lane marking from a surrounding portion of the captured image. Other techniques based upon deep learning technology or another computer vision method may be used, if desired.

The object detection module 102 includes one or more image processing algorithms configured to identify objects in the captured images. The algorithms may be used to identify VRU's (e.g., pedestrians or cyclists), attributes of the tractor 12 and/or trailer 14, other vehicles, signs, curbs, trees, buildings and/or other inanimate objects.

The trailer end detection module 104 is another image processing module that extracts one or more trailer features from the captured images to determine the location of the end of the trailer in 3D space. These extracted attributes can be used to detect objects such as tractor wheels, trailer edges and other features. Example wheel detection algorithm techniques are disclosed in United States Publication No. US2023/202,394 entitled “CAMERA MONITOR SYSTEM FOR COMMERCIAL VEHICLES INCLUDING WHEEL POSITION ESTIMATION”, which is incorporated herein by reference in its entirety. Example trailer edge detection algorithm techniques are disclosed in United States Publication No. US2023/125,045 entitled “TRAILER END TRACKING IN CAMERA MONITORING SYSTEM”, which is incorporated herein by reference in its entirety. Other techniques may be used, if desired.

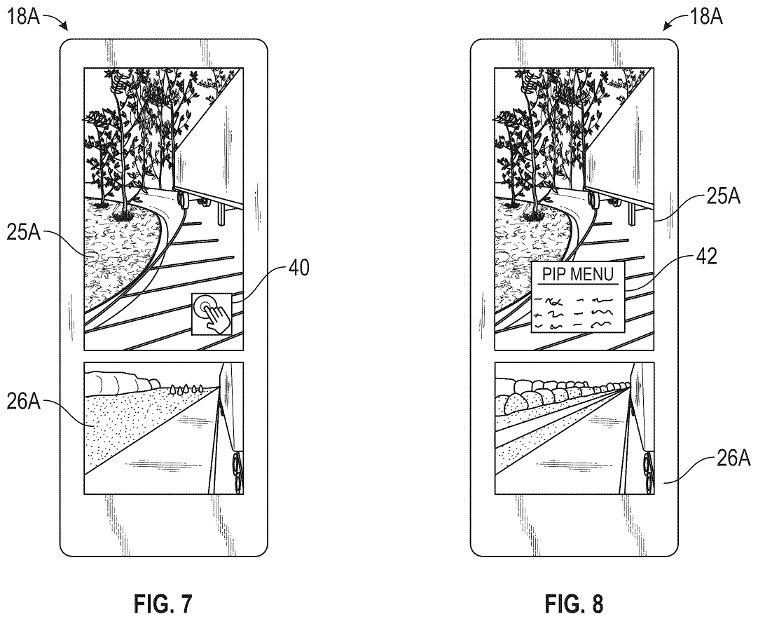

In one example operation, the CMS 15 utilizes the kinematics module 106 to predict a striking zone of the trailer 14 during a turn operation and generates a two dimensional overlay to digitally impose over at least one of the displayed Class II/IV images thereby showing the vehicle operator an expected striking zone of the trailer 14 and allowing the vehicle operator adjust the vehicle operations accordingly. The CMS 15 uses the received captured images from the cameras 20A, 20B, as well as any other cameras and vehicle operation data received from a general vehicle controller through a data connection, such as a CAN or LIN bus, to estimate a predicted position of the tractor and/or trailer side at each of multiple side positions and multiple points in time. These positions are converted to a geometric area encompassing all the positions. In this way, the shape and size of the geometric area is not fixed, but rather reflects an actual predicted striking area of the trailer (e.g., see, FIGS. 7 and 8).

In order to avoid accidental strikes, the striking area prediction system uses the vehicle data (e.g. steering angle, steering rate, trailer angle, vehicle speed, trailer wheelbase, tractor wheelbase, hitch point location, yaw rate and the like) to generate a predicted striking zone over time. The predicted striking zone is a prediction of the path the trailer will take over the course of the turn and is re-calculated continuously as the turn progresses. The trailer striking area is also useful in a potential “curve cut” scenario when the vehicle 10 is traveling down a curved roadway. In a curvy road, it becomes more likely for the trailer end to cross the lane markers. indicating boundaries to adjacent lanes, creating a potentially dangerous situation.

The CMS 15 includes a Decision Manager or Collision Alert Module 112 that communicates with the modules 100-110 to evaluate the proximity between the predicted tractor and/or trailer paths (i.e., the tractor and trailer striking areas) and one or more objects (e.g., predicting an imminent curb strike, curve cut, object collision etc.). The decision manager considers the estimated time to the event, severity (what the object is), closing rate between objects, etc. and may provide an overlay and/or alert.

While various overlays and alerts may useful in increasing operator awareness and enhancing safety, it is desirable to provide the operator with information to more easily and proactively manage the vehicle to safely navigate through its surroundings. One such approach is to provide a Picture-in-Picture (PIP) window on at least one of the displays during various operational states in anticipation of what display the operator is likely to be viewing while navigating that operational state. This enables the operator to assimilate more, useful information provided by the CMS while also limiting distractions.

As will be discussed below in greater detail, the CMS 15 includes functionality for providing operator selectable predetermined PIP configurations to display CMS images based on touchscreen commands received through a touchscreen interface. The touchscreen interface may be provided on one of the CMS displays, or through a separate touchscreen interface. For example, a “bring your own device” configuration may be supported, in which a vehicle occupant can use their own personal device (e.g., a tablet) as a CMS display and/or a touchscreen interface (e.g., a tablet).

The touchscreen of at least one of the displays 18A-18D and 18G-18H, if so provided, can be used to enable the (PIP) option to support providing the right information to the operator at the right time. In one example, the driver side display 18A or secondary information display 18D are used as the primary display for managing desired PIP configurations across all displays (e.g., for turning ON or OFF preset PIP window options), as these displays are within easy reach of the operator. It is also possible that a display within reach of a passenger may be used to enable the PIP functionality. As one example, the left-hand display 18A servers as the primary display, and display area 25A provides the touchscreen.

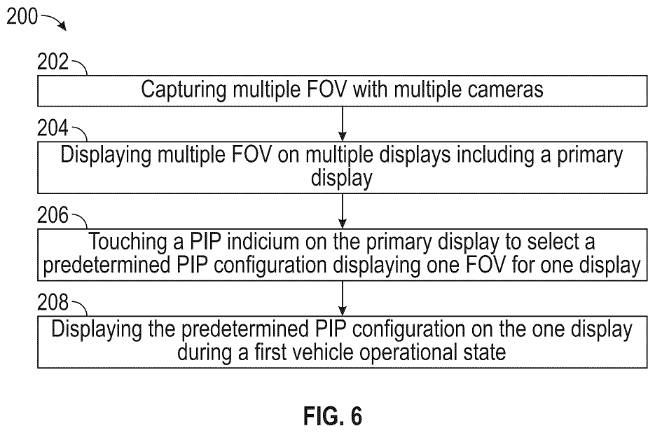

FIG. 6 is a flowchart of an example method 200 for the CMS 15. During operation of the vehicle 10, multiple fields of view (e.g., FOV_{EX1}, FOV_{EX2}, FOV_{EX3}, FOV_{EX4}) are captured with the cameras (e.g., cameras 20A-20E; block 202) and displayed on the displays (e.g., displays 18A-18H; block 204)). At least one of the displays serves as primary display (e.g., display 18A) with which the operator may interface to select a PIP option. In one example, the operator touches the touchscreen on the primary display, which brings up a picture-in-picture (PIP) indicium 40 (FIG. 7), which the operator can then touch (block 206) to bring up a PIP options menu 42 (FIG. 8). From this PIP options menu, the operator can select a predetermined PIP configuration that will display a streaming image from one of the multiple fields of view on at least one of the multiple displays 18A-18G (block 208) during a first vehicle operational state.

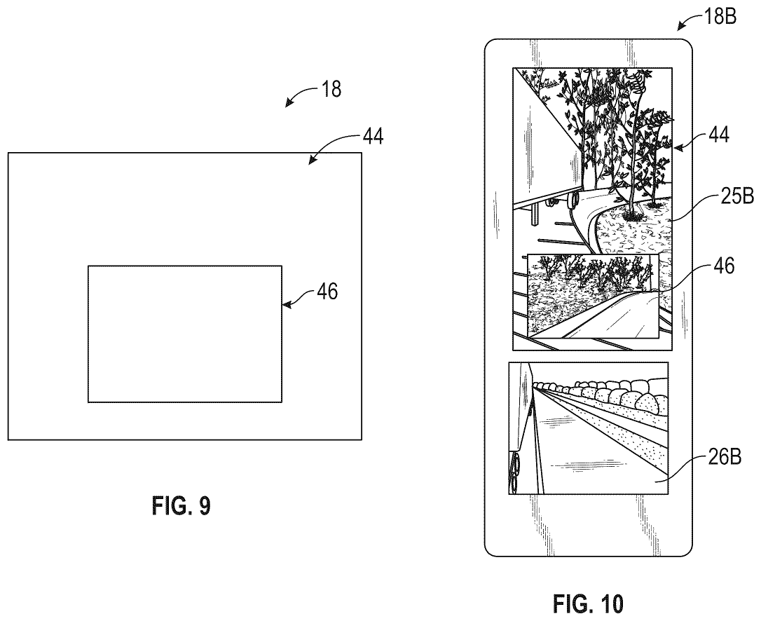

The predetermined PIP configuration corresponds to displaying the streaming image on at least one of the multiple displays (e.g., the primary display, another display, or any combination of displays) during a first vehicle operational state. That is, the predetermined PIP configuration will superimpose a PIP window 46 containing an image feed from at least one camera on top of the background image 444 from that camera or another camera that is being displayed, as shown in FIG. 9. The ECU 22 determines when the first operation state occurs (e.g., based upon speed, gear, turning angle, etc.) and may automatically provide the desired PIP window according to the selected predetermined PIP configuration. However, the PIP window will cease being displayed during a second vehicle operational state that is different than the first vehicle operational state, for example, based upon a triggering event. The triggering event may be based upon speed, gear, turning angle or other changes in vehicle operating state. Instead or additionally, the triggering event may be based upon a predetermined time elapsing (e.g., the PIP window will only be displayed for X seconds before timing out and reverting to the prior display configuration).

While it will be appreciated that the disclosed method can be useful in a variety of vehicle operational states, the following description illustrates several examples.

### Example 1

It is desirable to provide the operator improved visibility when operating in a reverse gear. Although a rearview camera image may be displayed on another display (e.g., one or more of displays 18C, 18D, 18F, 18G, 18H), it may be useful for the operator to also have the rearview camera image displayed on the same display that the operator would typically look at during such a maneuver. To this end, the first vehicle operational state is triggered when the vehicle is in a reverse gear and a “Reverse” PIP option is selected (e.g., from the PIP options menu). For this PIP configuration, one of the multiple fields of view includes PIP window of an image in proximity to a rear of a trailer (e.g., enlarged view at trailer end from camera 20A and/or 20B, or a rearview provided by camera 20D and/or 20E). The predetermined PIP configuration corresponds to displaying the image on the at least one of the multiple displays, for example, on one or both of the displays 18A, 18B. Display of the PIP window may timeout once the operator shifts the vehicle into a forward gear.

### Example 2

In another example, during turning maneuvers the operator may spend more time focusing one side view over another side view, particularly on the inside turning radius of the vehicle, as that side of the vehicle is at increased risk of a curb strike or the like. As a result, the operator may not give sufficient attention to the display on the opposite side of the vehicle, e.g., the side corresponding to the outside radius. The first vehicle operational state includes the vehicle providing an inside turning radius and a trailer angle is above a threshold. For example, this “Turn” PIP option may be automatically triggered when the steering angle is above 15 degrees, for example. At least one of the displays 18A, 18B (and, if desired, both displays 18A, 18B) include a PIP window of an image of a side of the trailer opposite the side of the display (i.e., left-hand side display 18A includes a PIP window from the right-hand camera 20B, and/or the right-hand side display 18B includes a PIP window from the left-hand camera 20A). FIG. 10 illustrates one such example, in which a PIP window 46 from the left-hand camera 20A is superimposed on the Class II background image 44 (illustrating a view of an inside turning radius) on the right-hand display 18B. Display of the PIP window may timeout once the vehicle's steering angle is above the threshold.

### Example 3

At low speeds and starting from a stop it may be useful to have enhanced visibility at the front of the vehicle, as these operating conditions are common when pedestrians or vulnerable road users (VRU) are present and difficult to see. Even with vehicles equipped with a front camera 20C (providing Class V and/or VI views, for example, displayed on display 18C), the operator may not view the display 18C frequently enough in heavily active areas, as the displays 18A, 18B may require significant attention as well. In this example, the first vehicle operational state includes the vehicle being in a forward gear and below a speed threshold, for example, 10 mph. One of the multiple fields of view includes an image of a passenger side of the vehicle from a passenger vehicle cab corner aftward along a cab of the vehicle (e.g., Class V view from camera 20C). The predetermined PIP configuration corresponds to displaying a PIP window including the image on at least one of the multiple displays, for example, displays 18A and/or 18B. Display of the PIP window may timeout once the vehicle's speed is above the speed threshold.

### Example 4

Similar to Example 3, the operator may desire additional displays of the front of the cab. In this example, the first vehicle operational state includes the vehicle being in a forward gear and below a speed threshold, for example, 10 mph. One of the multiple fields of view includes an image of a passenger side of the vehicle from a passenger vehicle cab corner along a front of a cab of the vehicle (e.g., Class VI view from camera 20C). The predetermined PIP configuration corresponds to displaying a PIP window including the image on at least one of the multiple displays, for example, displays 18A and/or 18B. Display of the PIP window may timeout once the vehicle's speed is above the speed threshold.

### Example 5

The operator may want a perimeter view of the vehicle's surroundings, for example, while parked or at relatively low speeds. The first vehicle operational state includes the vehicle being below a speed threshold (e.g., below 5 mph), and the multiple fields of view form a bird's eye view (BEV), which is typically obtained by stitching multiple views from multiple cameras around the perimeter of the vehicle. The predetermined PIP configuration corresponds to displaying the BEV on at least one of the multiple displays. Display of the PIP window may timeout once the speed is above the speed threshold, or after a predetermined amount of time has elapsed.

### Example 6

Operators are vigilant about the presence and location of VRUs, particularly at low speeds and in heavy traffic. While Examples 1-5 may be used in anticipation of VRU risk, in this example, VRUs are actively detected and located using image processing data from the cameras 20A-20E and/or using other sensor data (e.g., ultrasonic, LiDar, radar, etc.). The first vehicle operational state includes detecting a VRU with the sensor and then displaying a PIP window with the VRU on at least one of the multiple displays. Display of the PIP window may timeout once the VRU exceeds a given distance from the vehicle and/or the trajectory of the vehicle or VRU changes such that the VRU no longer poses a risk.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of providing views in a camera monitor system for a vehicle, comprising:
a) capturing multiple fields of view with multiple cameras;
b) displaying the multiple fields of view on multiple displays, one of which includes a primary display;
c) touching a picture-in-picture (PIP) indicium on the primary display to select a predetermined PIP configuration displaying one of the multiple fields of view for at least one of the multiple displays; and
d) displaying the predetermined PIP configuration on the at least one of the multiple displays during a first vehicle operational state, the predetermined PIP configuration is absent from the at least one of the multiple displays during a second vehicle operational state that is different than the first vehicle operational state.

2. The method of claim 1, wherein the multiple displays include a driver side display and a passenger side display, the driver side display and passenger side display respectively mounted in close proximity to a driver side A-pillar and a passenger side A-pillar, wherein each of the driver side display and passenger side display provide a narrow angle view and a wide angle view of its respective side of the vehicle that is provided by the multiple fields of view.

3. The method of claim 2, wherein the multiple displays include at least one of a primary information display located behind a steering wheel, a secondary information display located centrally in a bottom half of a vehicle cabin, a front passenger side corner display located centrally in a top half of the vehicle cabin, and a heads-up display.

4. The method of claim 2, wherein the primary display corresponds to the driver side display.

5. The method of claim 1, wherein the primary display includes a touchscreen, and step c) is performed by touching the touchscreen.

6. The method of claim 5, wherein comprising a step of touching the touchscreen to display the PIP indicium prior to performing step c), and step c) includes displaying a PIP options menu in response to touching the PIP indicium, the PIP options menu includes the predetermined PIP configuration.

7. The method of claim 6, wherein the PIP options menu includes at least one of the following predetermined PIP configurations:
a PIP window of an image in proximity to a rear of a trailer of the vehicle;
a PIP window of an image of a side of the trailer opposite a side of the at least one of the multiple displays;
a PIP window of an image of a passenger side of the vehicle from a passenger vehicle cab corner aftward along a cab of the vehicle;
a PIP window of an image of a passenger side of the vehicle from a passenger vehicle cab corner along a front of the cab;
a PIP window of an image of a bird's eye view around the vehicle; and
a PIP window of an image of a vulnerable road user.

8. The method of claim 1, wherein the predetermined PIP configuration relates to one of the multiple displays other than the primary display.

9. The method of claim 1, wherein step d) is performed automatically in response to the first vehicle operational state occurring, and comprising a step e) of terminating the display of the predetermined PIP configuration based upon a triggering event.

10. The method of claim 1, wherein the first vehicle operational state includes the vehicle being in a reverse gear, one of the multiple fields of view includes an image in proximity to a rear of a trailer of the vehicle, and the predetermined PIP configuration corresponds to displaying the image on the at least one of the multiple displays.

11. The method of claim 1, wherein the first vehicle operational state includes the vehicle providing having a trailer angle above a threshold, one of the multiple fields of view includes an image of a side of the trailer opposite a side on which the one of the multiple fields of view is located, and the predetermined PIP configuration corresponds to displaying the image on the at least one of the multiple displays.

12. The method of claim 1, wherein the first vehicle operational state includes the vehicle being in a forward gear and below a speed threshold, one of the multiple fields of view includes an image of a passenger side of the vehicle from a passenger vehicle cab corner aftward along a cab of the vehicle, and the predetermined PIP configuration corresponds to displaying the image on the at least one of the multiple displays.

13. The method of claim 1, wherein the first vehicle operational state includes the vehicle being in a forward gear and below a speed threshold, one of the multiple fields of view includes an image of a passenger side of the vehicle from a passenger vehicle cab corner along a front of a cab of the vehicle, and the predetermined PIP configuration corresponds to displaying the image on the at least one of the multiple displays.

14. The method of claim 1, wherein the first vehicle operational state includes the vehicle being below a speed threshold, and the multiple fields of view form a bird's eye view (BEV), and the predetermined PIP configuration corresponds to displaying the BEV on the at least one of the multiple displays.

15. The method of claim 1, wherein the first vehicle operational state includes detecting a vulnerable road user (VRU), one of the multiple fields of view includes an image of the VRU, and the predetermined PIP configuration corresponds to displaying an image including the VRU on the at least one of the multiple displays.

16. A camera monitor system (CMS), comprising:
multiple cameras configured to capture multiple fields of view in proximity to a commercial vehicle;
multiple displays configured to display images from the captured multiple fields of view, the multiple displays including a primary display having a picture-in-picture (PIP) indicium; and
a controller in communication with the multiple cameras and the multiple displays, the controller configured to select a predetermined PIP configuration responsive to a user touching the PIP indicium, and the controller configured to display the predetermined PIP configuration on the at least one of the multiple displays during a first vehicle operational state, the predetermined PIP configuration is absent from the at least one of the multiple displays during a second vehicle operational state that is different than the first vehicle operational state.

17. The CMS of claim 16, wherein the multiple displays include a driver side display and a passenger side display, the driver side display and passenger side display respectively mounted in close proximity to a driver side A-pillar and a passenger side A-pillar, wherein each of the driver side display and passenger side display provide a narrow angle view and a wide angle view of its respective side of the vehicle that is provided by the multiple fields of view, and wherein the multiple displays include at least one of a primary information display located behind a steering wheel, a secondary information display located centrally in a bottom half of a vehicle cabin, a front passenger side corner display located centrally in a top half of the vehicle cabin, and a heads-up display.

18. The CMS of claim 16, wherein the primary display includes a touchscreen, wherein the controller is configured to display the PIP indicium in response to the user touching the touchscreen, the controller configured to display a PIP options menu in response to the user touching the PIP indicium, wherein the PIP options menu includes the predetermined PIP configuration, and the controller is configured to select the predetermined PIP configuration in response to the user touching the predetermined PIP configuration from the PIP options menu.

19. The CMS of claim 18, wherein the PIP options menu includes at least one of the following predetermined PIP configurations:
a PIP window of an image in proximity to a rear of a trailer of the vehicle;
a PIP window of an image of a side of the trailer opposite a side of the at least one of the multiple displays;
a PIP window of an image of a passenger side of the vehicle from a passenger vehicle cab corner aftward along a cab of the vehicle;
a PIP window of an image of a passenger side of the vehicle from a passenger vehicle cab corner along a front of the cab;
a PIP window of an image of a bird's eye view around the vehicle; and
a PIP window of an image of a vulnerable road user.

20. The CMS of claim 16, wherein the controller is configured to display the predetermined PIP configuration automatically in response to the first vehicle operational state occurring, and the controller configured to terminate the display of the predetermined PIP configuration based upon a triggering event.
